(19) United States
(12) Patent Application Publication
(10) Pub. No.: US 2017/0004743 A1
(43) Pub. Date: Jan. 5, 2017

(54) Magnetic Display Related to Athletic Contests

(71) Applicants: Christopher Paul Whitaker, Deland, FL (US); Deborah Leigh Whitaker, Deland, FL (US)

(72) Inventors: Christopher Paul Whitaker, Deland, FL (US); Deborah Leigh Whitaker, Deland, FL (US)

(21) Appl. No.: 15/202,457

(22) Filed: Jul. 5, 2016

Related U.S. Application Data
(60) Provisional application No. 62/188,577, filed on Jul. 3, 2015.
(60) Provisional application No. 62/221,810, filed on Sep. 22, 2015.

(51) Int. Cl. G09F 7/04; G09F 15/00

(52) U.S. Cl. CPC G09F 7/04; G09F 15/005

(57) ABSTRACT

A magnetic display that allows for fans to display the most recent scores of athletic contests in which the fans' team has most recently competed. The system has a magnetic base for attachment to a vehicle and a plurality of magnetic tiles that have numbers and indicia of relevant teams to be used with the magnetic base.

### REFERENCE TO RELATED CASE

This application claims priority under 35 U.S.C. §119 (e) to provisional application No. 62/188,577 filed on Jul. 3, 2015, and to provisional Ser. No. 62/221,810 filed on Sep. 22, 2015, the contents of which are hereby incorporated by reference in their entirety.

### BACKGROUND OF THE INVENTION

### Field of the Invention

Many sports fans like to display the accomplishments of the teams they support. One way to show support is to display the most recent score of contests involving the athletic teams. Before, it was simple to have a shirt made or to buy a shirt with the scores and wear it to show support. However, there are a limited number of people that can see the shirt when the fan wears it, particularly as the fan travels from place to place, i.e., running errands. Most fans would like to be able to display the accomplishments of their teams to more people, but there are limitations on the lengths to which some fans will go. For example, some fans would not paint their cars the same colors as the team colors. Nor would they want to permanently mark on the automobiles. A temporary display would, however, be more appealing to more fans.

Thus, presented herein is a magnetic display that allows for fans to display the most recent scores of athletic contests in which the fans' team has most recently competed.

### SUMMARY OF THE INVENTION

The present invention is directed to a system for displaying scores of an athletic contest on a vehicle that includes a magnetic base having a plurality of areas for locating athletic team information and scores, the magnetic base being of a size and configuration to be magnetically adhered to a surface of a vehicle and a plurality of magnetic tiles, the plurality of magnetic tiles comprising a first plurality of magnetic tiles having numbers thereon and a second plurality of magnetic tiles having indicia thereon corresponding to athletic teams.

In some embodiments, the system also includes a dry-erase marker to write on at least one of the magnetic base and the plurality of magnetic tiles.

In some other embodiments, the indicia on each of the second plurality of magnetic tiles having indicia thereon comprises the name or a logo of an athletic team.

In another embodiment, the plurality of areas includes cut-outs to receive at least one of the plurality of magnetic tiles therein.

According to another aspect of the present invention a system for displaying scores of an athletic contest on a vehicle includes a magnetic base having a plurality of areas for locating athletic team information and scores, the magnetic base being of a size and configuration to be magnetically adhered to a surface of a vehicle, a plurality of magnetic tiles, the plurality of magnetic tiles comprising a first plurality of magnetic tiles having numbers thereon and a second plurality of magnetic tiles having indicia thereon corresponding to athletic teams, and a dry-erase marker to write on at least one of the magnetic base and the plurality of magnetic tiles.

In some embodiments, the system is directed to athletic teams that play a sport from the group of sports consisting of baseball, football, soccer, basketball, lacrosse, volleyball, swimming, badminton, hockey, field hockey, softball, water polo, and rugby.

It is to be understood that both the foregoing general description and the following detailed description of the present embodiments of the invention are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 illustrates a first embodiment of a magnetic display according to the present invention;

FIG. 2 illustrates components that can be used with the first embodiment;

FIG. 3 illustrates a second embodiment of a magnetic display according to the present invention;

FIG. 4 illustrates a third embodiment of a magnetic display according to the present invention;

FIG. 5 illustrates a fourth embodiment of a magnetic display according to the present invention;

FIG. 6 illustrates a fifth embodiment of a magnetic display according to the present invention; and

FIGS. 7 and 8 illustrates an alternative configuration of placing the magnetic tiles on the magnetic base in FIG. 6.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

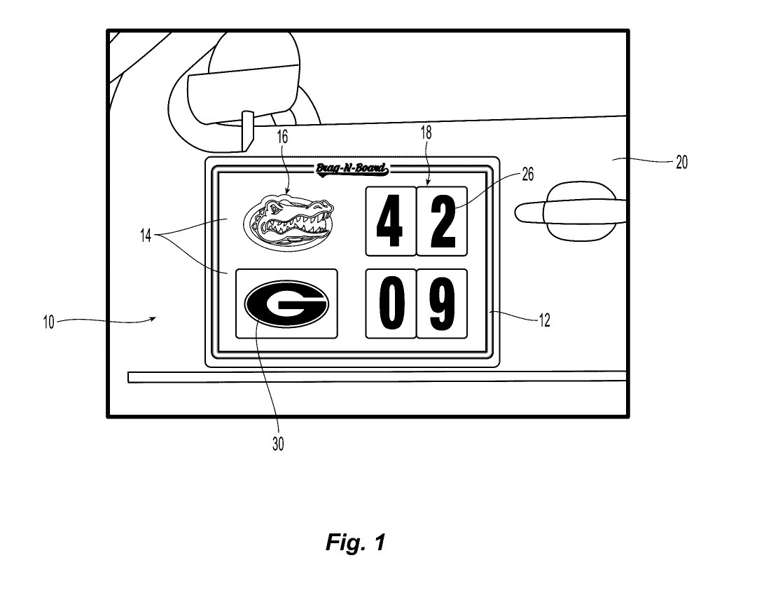

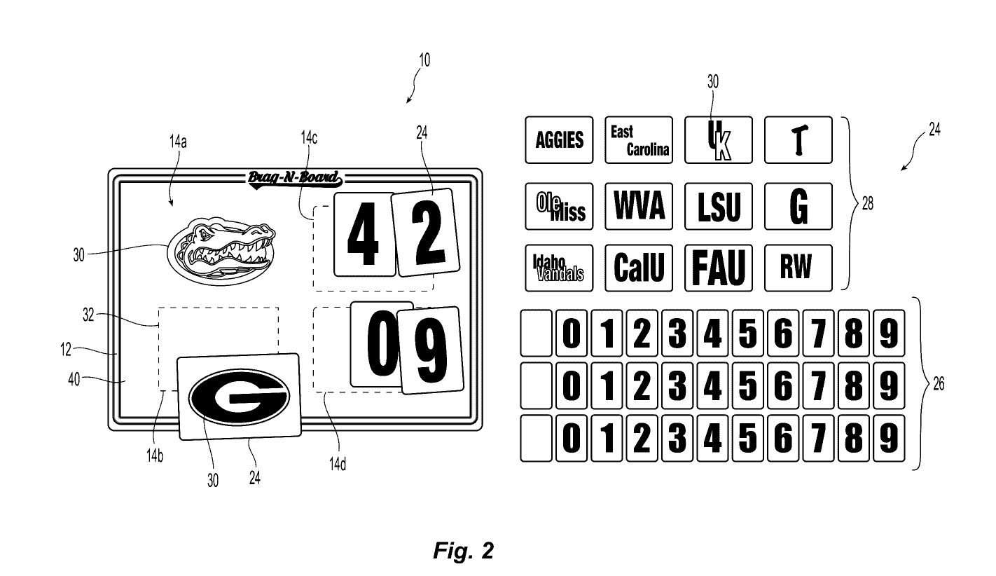

Referring to FIGS. 1 and 2, one embodiment of a system 10 for displaying scores of an athletic contest on a vehicle is illustrated. The system 10 has a magnetic base 12 that has a plurality of areas 14 for locating athletic team information 16 and scores 18. As illustrated in FIG. 1, the magnetic base 12 is preferably of a size and configuration that is easily adhered to a surface of a vehicle 20 and particularly the vehicle door. The magnetic base 12 is small enough to be attached to a door panel on the vehicle 20, yet large enough to be seen while the vehicle 20 is underway.

The system 10 also includes a plurality of magnetic tiles 24 that are to be used with the magnetic base 12. See FIG. 2. The plurality of magnetic tiles 24 includes a first plurality of magnetic tiles 26 having numbers on the faces thereof and are used to display the score of the athletic contest. The plurality of magnetic tiles 24 also includes a second plurality of magnetic tiles 28, each of the second plurality of magnetic tiles having an indicia 30 thereon corresponding to athletic teams. The indicia 30 corresponds to the team name, mascot, logos, etc., of the teams that would be included with the system 10, as described in more detail below.

Turning back to the magnetic base 12, it has areas 14a, 14b, 14c, 14d for the team information (from the second plurality of magnetic tiles 28) and the scoring information (from the first plurality of magnetic tiles 26). In the embodiment illustrated in FIGS. 1 and 2, the preferred team (that supported by the owner of the system 10) is permanently printed in the upper left area 14a of the magnetic base 12. Directly below the preferred team is the area 14b for the other team that is involved in the athletic contest. The area 14b may have an outline 32 to show where to attach one of the second plurality of magnetic tiles 28, the magnetic tile having the indicia 30 of the opposing team.

The magnetic base 12 is preferably a flexible magnetic panel that is suitable for automotive finishes. Thus, the magnetic base 12 will not scratch the automotive finish and can be removed and applied easily. As noted below, it is also preferable that the magnetic base 12 also has a coating that allows for the use of a dry-erase marker (the marker ink does not permanently adhere to the surface of the magnetic base 12).

The two other areas 14c and 14d may also have outlines to illustrate where the scores for each of the teams are to be located. As noted above, a few of the first plurality of magnetic tiles 26 having numbers on the faces thereof are positioned in areas 14c,14d to display the scores. The system 10 preferably includes three sets of magnetic tiles 26 that have numbers from 0-9. Three sets of numbers from 0-9 allows for most combinations of scores. A few blank magnetic tiles 26 may also be included.

The second plurality of magnetic tiles 28 having an indicia 30 thereon corresponding to athletic teams may have any appropriate number of magnetic tiles 28. For example, if the owner of the system 10 favors a team in the Atlantic Coast Conference, there would be 14 different tiles (15 members of the ACC and one would be permanently adhered to the magnetic base 12). In the Southeastern Conference, there are 18 teams and thus 17 different magnetic tiles would be supplied for the system 10. A similar system would be applicable for professional sports teams and leagues. The names of the universities (or schools), the cities, or mascots of the teams could be used as the indicia. Alternatively, a picture of the mascots or the team logo could also be used.

It is also contemplated that single magnetic tiles would be available for special occasions. For example, while a supporter of an SEC team would want all of the other SEC teams, the supporter may also want the magnetic tile 28 for a team that was going to be played in a bowl game. For the professional sports, the supporter may want the magnetic tiles 28 for the playoffs and any championship games.

The magnetic base 12 may also have other markings to further enhance the bragging experience. For example, the magnetic base 12 may have other indicia 30 of the preferred team, including the team colors in a band 40 around the periphery of the magnetic base 12. However, other elements may be added to the magnetic base 12 and still fall within the present invention.

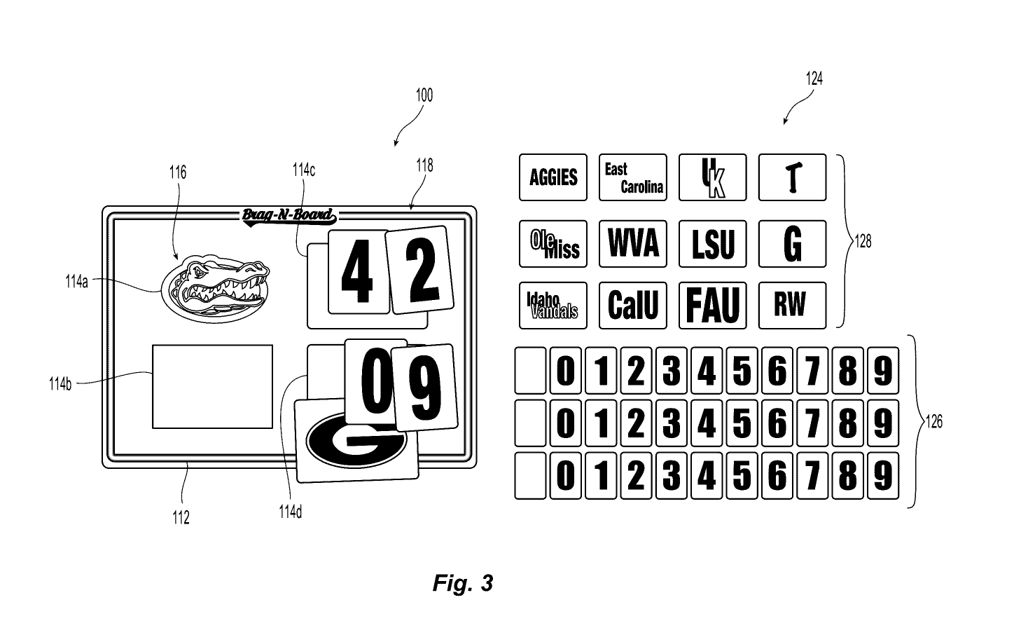

Another embodiment of a system 100 is illustrated in FIG. 3. The system 100 also has a magnetic base 112 that has a plurality of areas 114 for locating athletic team information 116 and scores 118.

The system 100 also includes a plurality of magnetic tiles 124 that are to be used with the magnetic base 112 as with the prior embodiment. However, in this embodiment, areas 114b, 114c, 114d for the team information (from the second plurality of magnetic tiles 128) and the scoring information (from the first plurality of magnetic tiles 126) are cut-outs in the magnetic base 112, rather than just marked areas as noted above. In this way, the plurality of magnetic tiles 124 are positioned within the cut-outs 114b, 114c, and 114d and adhered directly to the vehicle on which the magnetic base 112 is adhered and presents a smooth face. As with the prior embodiment, the preferred team (that supported by the owner of the system 100) is permanently printed in the upper left area 114a of the magnetic base 112.

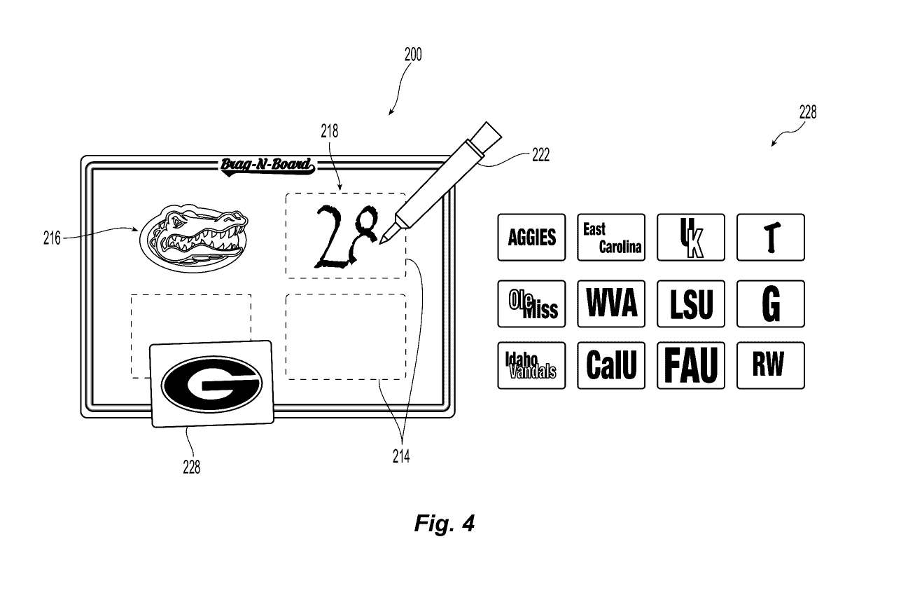

Another embodiment of a system 200 is illustrated in FIG. 4. The system 200 also has a magnetic base 212 that has a plurality of areas 214 for locating athletic team information 216 and scores 218. The system 200 also includes a plurality of magnetic tiles 228 that include the the team information. However, system 200 includes a dry-erase marker 222, rather than a plurality of magnetic tiles that include the numbers to make the scores on the magnetic base 212. It should be noted that the dry-erase marker 222 may also be included with the other embodiments to be used as an alternative way to display scores or with the blank tiles.

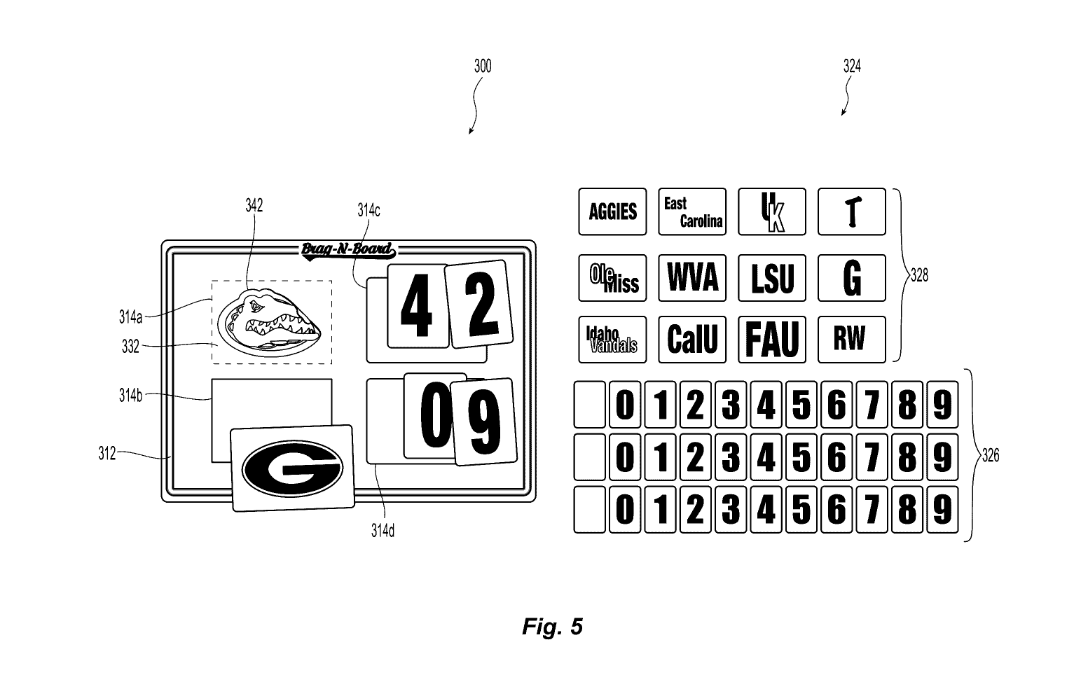

Another embodiment of a system 300 is illustrated in FIG. 5. The system 300 also has a magnetic base 312 that has a plurality of areas 314 for locating athletic team information 316 and scores 318. However, rather than having the preferred team permanently printed on the in the upper left area 314a, the preferred team is provided as a cling-on label 342 that carries the indicia 330 of the team. While there are a plurality of magnetic tiles 328 for the other teams, those too could be cling-on labels 342. While there are a plurality of magnetic tiles 326 for the numbers, those too could be provided as cling-on labels 342. In the event that the team and scoring information is provided by cling-on labels, then the plurality of areas 314 would not be openings as illustrated in FIG. 5, but the magnetic base 312 would be a solid magnetic base 312 with outlines 332 to locate the cling-on labels.

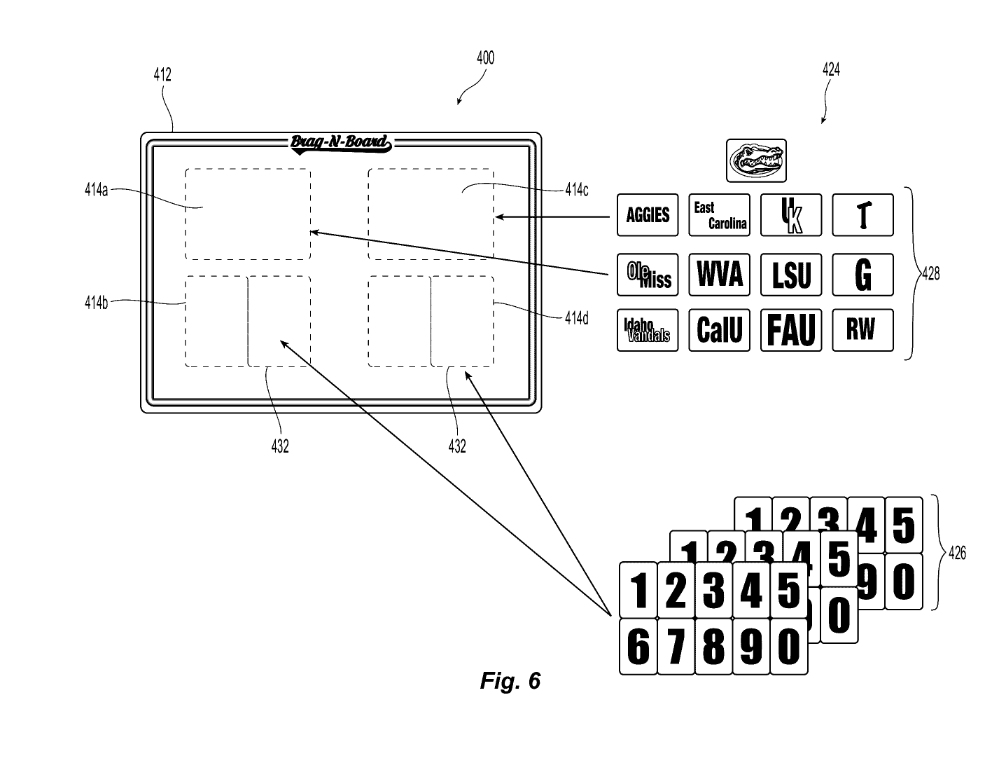

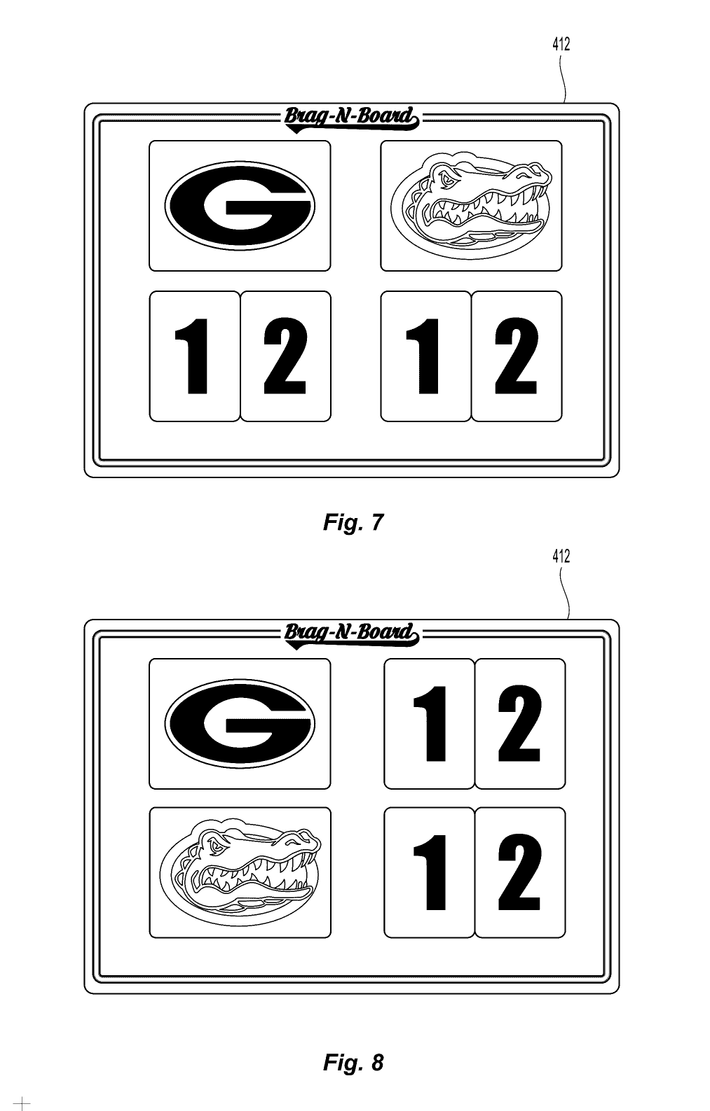

Another embodiment of a system 400 is illustrated in FIGS. 6-8. In this embodiment, the magnetic base 412 has areas 414a, 414b, 414c, and 414d for the team information (from the second plurality of magnetic tiles 428) and the scoring information (from the first plurality of magnetic tiles 426). In this embodiment, there is no preferred team and the plurality of magnetic tiles 424 are used in all four areas 414a, 414b, 414c, and 414d. Alternatively, cling-on labels rather than the magnetic tiles can be used as well, since the magnetic base 412 is illustrated with outlines 432 to indicate the positions of the teams and the scores. If the plurality of magnetic tiles 424 are used exclusively with the magnetic base 412, then the areas 414a, 414b, 414c, and 414d could also be cut outs. One of the advantages of the system 400 is to allow the user more freedom in where to place the the plurality of magnetic tiles 424. For example, as illustrated in FIG. 7, the teams could be along the top of the magnetic base 412, or they could be down the side as illustrated in FIG. 8.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

We claim:

1. A system for displaying scores of an athletic contest on a vehicle comprising:
a magnetic base having a plurality of areas for locating athletic team information and scores, the magnetic base being of a size and configuration to be magnetically adhered to a surface of a vehicle; and
a plurality of magnetic tiles, the plurality of magnetic tiles comprising a first plurality of magnetic tiles having numbers thereon and a second plurality of magnetic tiles having indicia thereon corresponding to athletic teams.

2. The system for displaying scores of an athletic contest according to claim 1, further comprising a dry-erase marker to write on at least one of the magnetic base and the plurality of magnetic tiles.

3. The system for displaying scores of an athletic contest according to claim 1, wherein the magnetic base further comprises colored areas, the colored areas corresponding to the team colors of one of the teams.

4. The system for displaying scores of an athletic contest according to claim 1, wherein the indicia on each of the second plurality of magnetic tiles having indicia thereon comprises the name or a logo of an athletic team.

5. The system for displaying scores of an athletic contest according to claim 1, wherein the plurality of areas includes cut-outs to receive at least one of the plurality of magnetic tiles therein.

6. The system for displaying scores of an athletic contest according to claim 2, wherein the magnetic base and plurality of magnetic tiles have a surface suitable for writing thereon with the dry-erase marker.

7. The system for displaying scores of an athletic contest according to claim 1, wherein each of the first plurality of magnetic tiles has a single number thereon.

8. The system for displaying scores of an athletic contest according to claim 1, wherein each of the first plurality of magnetic tiles has a size that is one half that of each of the second plurality of magnetic tiles.

9. The system for displaying scores of an athletic contest according to claim 1, further comprising at least one cling-on label, the at least one cling-on label having indicia thereon corresponding to an athletic team and being capable of adhering to the magnetic base.

10. A system for displaying scores of an athletic contest on a vehicle comprising:
a magnetic base having a plurality of areas for locating athletic team information and scores, the magnetic base being of a size and configuration to be magnetically adhered to a surface of a vehicle;
a plurality of magnetic tiles, the plurality of magnetic tiles comprising a first plurality of magnetic tiles having numbers thereon and a second plurality of magnetic tiles having indicia thereon corresponding to athletic teams; and
a dry-erase marker to write on at least one of the magnetic base and the plurality of magnetic tiles.

11. The system for displaying scores of an athletic contest according to claim 10, wherein the indicia on the second plurality of magnetic tiles correspond to athletic teams from one athletic conference.

12. The system for displaying scores of an athletic contest according to claim 10, wherein the indicia on the second plurality of magnetic tiles correspond to professional athletic teams.

13. The system for displaying scores of an athletic contest according to claim 10, wherein the indicia on the second plurality of magnetic tiles correspond to collegiate athletic teams.

14. The system for displaying scores of an athletic contest according to claim 10, wherein the system is directed to athletic teams that play a sport from the group of sports consisting of baseball, football, soccer, basketball, lacrosse, volleyball, swimming, badminton, hockey, field hockey, softball, water polo, and rugby.
